(19) United States
(12) Patent Application Publication
(10) Pub. No.: US 2025/0296162 A1
(43) Pub. Date: Sep. 25, 2025

(54) SAWZALL FLUSH-CUT BLADE ATTACHMENT DEVICE

(71) Applicant: Edwin Martinez, Boonsboro, MD (US)

(72) Inventor: Edwin Martinez, Boonsboro, MD (US)

(21) Appl. No.: 19/052,976

(22) Filed: Feb. 13, 2025

Related U.S. Application Data
(60) Provisional application No. 63/569,413, filed on Mar. 25, 2024.

(51) Int. Cl. B23D 49/11; B23D 51/10

(52) U.S. Cl. CPC B23D 49/11; B23D 51/10

(57) ABSTRACT

A Sawzall flush-cut blade attachment device is provided. The device is designed for use with a reciprocating saw, such as a Sawzall, to enable precise flush cuts in hard-to-reach areas. The device comprises a body with a first end shaped to securely fit into the saw's chuck, featuring two 90-degree bends that allow for enhanced maneuverability and alignment. These bends position the blade along the saw's outer edge, facilitating efficient flush cutting. A blade-receiving member, attached to the second end of the body, holds the cutting blade securely via a fastener mechanism that allows for quick blade changes. The blade's design varies depending on the material being cut, ensuring versatility and precision in cutting wood, metal, plastics, and masonry. The invention also includes a method for using the device, detailing steps for installation and operation to achieve accurate flush cuts.

### CROSS-REFERENCE TO RELATED APPLICATION

The present application claims priority to, and the benefit of, U.S. Provisional Application No. 63/569,413, which was filed on Mar. 25, 2024, and is incorporated herein by reference in its entirety.

### FIELD OF THE INVENTION

The present invention relates generally to the field of Sawzall attachments. More specifically, the present invention relates to an attachment for a Sawzall that receives a Sawzall blade that allows the Sawzall blade to make a flush cut in a tight space. Accordingly, the present disclosure makes specific reference thereto. Nonetheless, it is to be appreciated that aspects of the present invention are also equally applicable to other like applications, devices, and methods of manufacture.

### BACKGROUND

When using a Sawzall tool, cutting any material smaller than 1.5 inches in thickness is a significant challenge due to the design limitations of the saw blade's support structure. The fixed position of the blade makes it difficult to maneuver in tight spaces or when trying to make flush cuts on various surfaces. Users are unable to adjust the blade's position to accommodate these different cutting needs, leading to frustration when attempting precise, close-to-surface cuts. While some may attempt to adjust the angle or position of the Sawzall tool itself to compensate, the bulky and thick nature of the tool often obstructs the desired adjustment, making the task even more cumbersome. This limitation hinders users from achieving the accuracy and precision required for delicate or detailed work, where a flush cut is essential for both functionality and aesthetics. As a result, Sawzall's design poses significant obstacles when trying to work with smaller materials or in confined spaces, making it less versatile for certain cutting applications where precision is key.

Therefore, there exists a long-felt need in the art for an improved Sawzall attachment. There also exists a long-felt need in the art for a Sawzall flush-cute blade attachment device. More specifically, there exists a long-felt need in the art for a Sawzall flush-cute blade attachment device that allows a Sawzall to be used in a tight space. Further, there exists a long-felt need in the art for a Sawzall flush-cute blade attachment device that allows a Sawzall to make a flush cut in a tight space.

The subject matter disclosed and claimed herein, in one embodiment thereof, comprises a Sawzall flush-cut blade attachment device. The device is comprised of a device designed for use with a reciprocating saw, such as a Sawzall, to enable precise flush cuts in hard-to-reach areas. The device comprises a body with a first end shaped to securely fit into the saw's chuck, featuring two 90-degree bends that allow for enhanced maneuverability and alignment. These bends position the blade along the saw's outer edge, facilitating efficient flush cutting. A blade-receiving member, attached to the second end of the body, holds the cutting blade securely via a fastener mechanism that allows for quick blade changes. The blade's design varies depending on the material being cut, ensuring versatility and precision in cutting wood, metal, plastics, and masonry. The invention also includes a method for using the device, detailing steps for installation and operation to achieve accurate flush cuts.

In this manner, the Sawzall flush-cut blade attachment device of the present invention accomplishes all the foregoing objectives and provides an improved Sawzall attachment. More specifically, the device allows a Sawzall to be used in a tight space. Further, the device allows a Sawzall to be used to make a flush cut within said tight space.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a Sawzall flush-cut blade attachment device. The device is comprised of a body with a first end that is shaped and dimensioned to fit securely into the chuck of a Sawzall. The first end is further comprised of a first bend, which is preferably formed at an approximately 90-degree angle to the right (when viewing the device from above) from the portion of the first end that is inserted into the chuck. This configuration is specifically designed to enable the blade to be positioned in such a way that it can perform flush cuts effectively, a critical function for cutting in tight or hard-to-reach spaces. Additionally, the first end is comprised of a second bend, also preferably angled at approximately 90 degrees, which further repositions a second end of the device so that it is parallel with the portion of the first end that is received by the chuck. This parallel alignment between the first end and the second end ensures that the device remains stable during cutting, minimizing unwanted vibrations or shifts. The bends together create a configuration that allows the attached blade to extend along the outside edge of the Sawzall, facilitating a flush cut along surfaces and edges that are otherwise difficult to reach using traditional Sawzall blades.

The device further includes at least one blade-receiving member for securely holding and positioning the blade. A first end of the blade-receiving member is attached to the second end of the body, ensuring that the member remains fixed and aligned with the overall structure of the device. The second end of the blade-receiving member is equipped with at least one fastener, which serves as the primary mechanism for attaching and securing the blade to the device.

The blade, which is received by the fastener, may be any type or style of cutting blade depending on the material being cut such as, but not limited to, a wood, metal, plastic, masonry, etc., cutting blade. It is preferably comprised of at least one tooth, designed to perform cutting tasks with precision and efficiency.

Accordingly, the Sawzall flush-cut blade attachment device of the present invention is particularly advantageous as it provides an improved Sawzall attachment. More specifically, the device allows a Sawzall to be used in a tight space. Further, the device allows a Sawzall to be used to make a flush cut within said tight space. In this manner, the Sawzall flush-cut blade attachment device overcomes the limitations of existing Sawzall's known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a Sawzall flush-cut blade attachment device of the present invention in a disassembled state and unattached to a Sawzall in accordance with the disclosed architecture;

FIG. 2 illustrates a perspective top view of one potential embodiment of a Sawzall flush-cut blade attachment device of the present invention in an assembled state and attached to a Sawzall in accordance with the disclosed architecture; and

FIG. 3 illustrates a flowchart of a method of using one potential embodiment of a Sawzall flush-cut blade attachment device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved Sawzall attachment. There also exists a long-felt need in the art for a Sawzall flush-cute blade attachment device. More specifically, there exists a long-felt need in the art for a Sawzall flush-cute blade attachment device that allows a Sawzall to be used in a tight space. Further, there exists a long-felt need in the art for a Sawzall flush-cute blade attachment device that allows a Sawzall to make a flush cut in a tight space.

The present invention, in one exemplary embodiment, is comprised of a Sawzall flush-cut blade attachment device comprised of a body with a first end designed to fit securely into the chuck of a Sawzall. The first end features a bend, preferably angled at approximately 90 degrees to the right (when viewed from above), allowing the blade to be positioned for effective flush cuts in tight or hard-to-reach areas. Additionally, the first end includes a second bend, also angled at around 90 degrees, which repositions the second end of the device to run parallel with the portion inserted into the chuck. This parallel alignment between the first and second ends ensures stability during cutting, reducing unwanted vibrations or movement. Together, the bends allow the blade to extend along the outer edge of the Sawzall, facilitating flush cuts along surfaces and edges that are typically hard to access with conventional Sawzall blades.

The device further includes a blade-receiving member attached to the second end of the body, which securely holds the blade in place. The second end of the blade-receiving member features at least one fastener, serving as the primary mechanism for attaching and securing the blade.

The blade, which is secured by the fastener, can be any type of cutting blade, such as those for cutting wood, metal, plastic, masonry, or other materials. It is preferably equipped with at least one tooth, designed for precise and efficient cutting.

Thus, the Sawzall flush-cut blade attachment device offers an improved attachment that allows the tool to perform flush cuts in confined spaces, overcoming the limitations of existing Sawzall's known in the art.

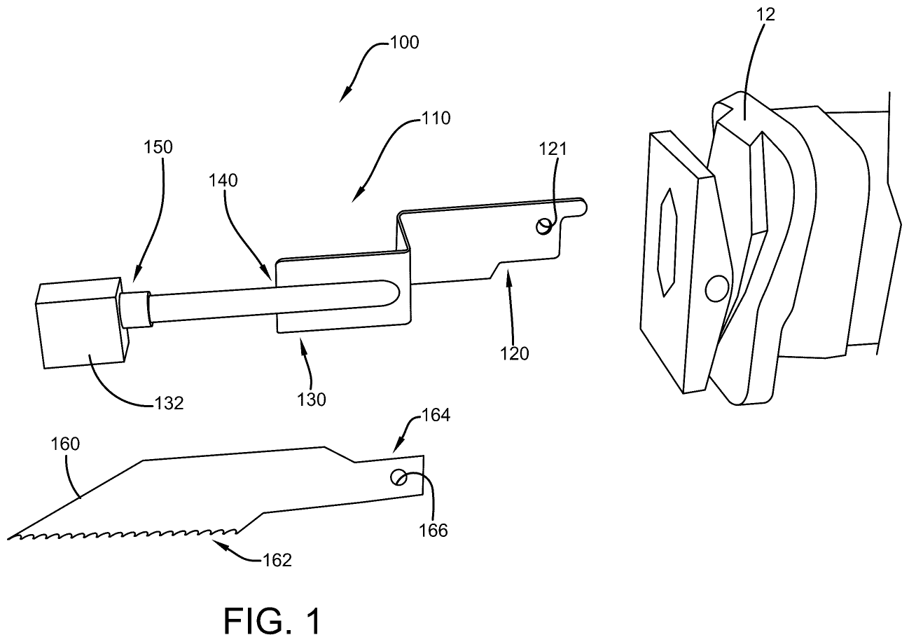

Referring initially to the drawings, FIG. 1 illustrates a perspective view of one potential embodiment of a Sawzall flush-cut blade attachment device 100 of the present invention in a disassembled state and unattached to a Sawzall in accordance with the disclosed architecture. The device 100 is comprised of a body 110, which may be constructed from various blade materials, including, but not limited to, high-carbon steel, high-speed steel, bi-metal, carbide-tipped materials, or diamond grit material, among others, depending on the specific application and cutting requirements. Portions of the body 110 may also be made of other metals. The body 110 is designed to provide durability, flexibility, and efficiency in cutting a wide range of materials, including wood, metal, plastics, and masonry. The body 110 includes a first end 120 that is shaped and dimensioned to fit securely into the chuck 12 of a Sawzall 10, allowing for easy and stable installation during operation. The first end 120 may be comprised of at least one opening 121 for the chuck 12 attachment.

The first end 120 is further comprised of a first bend 122, which is preferably formed at an approximately 90-degree angle to the right (when viewing the device 100 from above) from the portion of the first end 120 that is inserted into the chuck 12. This configuration is specifically designed to enable the blade to be positioned in such a way that it can perform flush cuts effectively, a critical function for cutting in tight or hard-to-reach spaces. The first bend 122 enhances the maneuverability and accessibility of the blade during operation.

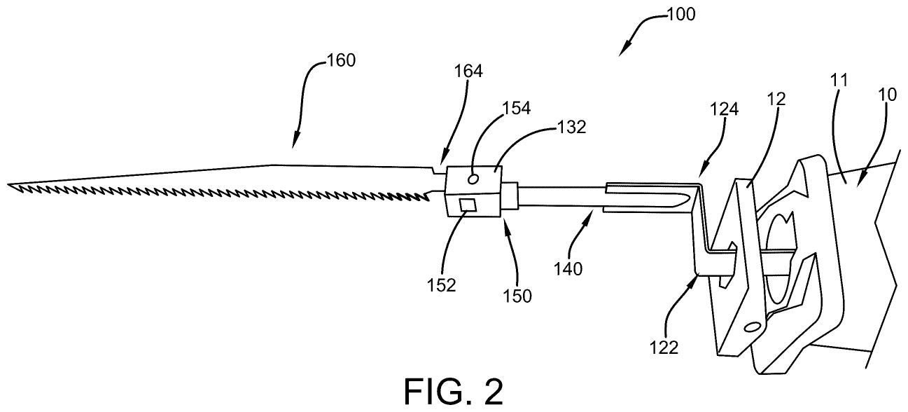

Additionally, the first end 120 is comprised of a second bend 124, also preferably angled at approximately 90 degrees, which further repositions a second end 130 of the device 100 so that it is parallel with the portion of the first end 120 that is received by the chuck 12. This parallel alignment between the first end 120 and the second end 130 ensures that the device 100 remains stable during cutting, minimizing unwanted vibrations or shifts. The bends 122 and 124 together create a configuration that allows the attached blade 160 to extend along the outside edge 11 of the Sawzall 10, facilitating a flush cut along surfaces and edges that are otherwise difficult to reach using traditional Sawzall blades, as seen in FIG. 2.

It should be appreciated that the body 110 may be any shape with any number of bends 122, 124 to allow for a flush cut to be made by a Sawzall.

The device 100 further includes at least one blade-receiving member 132 for securely holding and positioning the blade 160. A first end 140 of the blade-receiving member 132 is attached to the second end 130 of the body 110, ensuring that the member 132 remains fixed and aligned with the overall structure of the device 100. The second end 150 of the blade-receiving member 132 is equipped with at least one fastener 152, which serves as the primary mechanism for attaching and securing the blade 160 to the device 100.

The fastener 152 may take various forms, such as clamps, chucks, or other suitable fastening mechanisms designed to hold a Sawzall blade 160 in place during operation. In one embodiment, the fastener 152 is a spring-loaded fastener. More specifically, the fastener 152 can be unlocked via at least one button 154, lever, or similar control, allowing for the insertion of the tang 164 of the blade 160 into the fastener 152. Once inserted, the blade 160 is securely captured within the fastener 152, with the tang 164 and/or at least one opening 166 of the blade 160 may be engaged by a corresponding portion of the fastener 152, ensuring that the blade remains securely in place during use. This feature allows for quick and efficient blade changes without the need for additional tools.

The blade 160, which is received by the fastener 152, may be any type or style of cutting blade depending on the material being cut such as, but not limited to, a wood, metal, plastic, masonry, etc., cutting blade. It is preferably comprised of at least one tooth 162, designed to perform cutting tasks with precision and efficiency. The blade 160's teeth 162 are specially configured for different cutting applications, such as wood, metal, or composite materials, ensuring that the device 100 can be used in a variety of cutting operations. The secure attachment of the blade 160 to the blade-receiving member 132 ensures that the blade remains in position for flush cutting, providing enhanced control and accuracy during use.

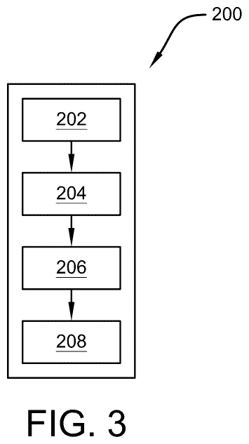

The present invention is also comprised of a method of using 200 the device 100, as seen in FIG. 3. First, the user provides a device 100 comprised of a body 110 comprised of a first end 120 that is shaped to fit into the chuck 12 of the reciprocating saw 10. The first end 120 is further comprised of a first bend 122, which is angled approximately 90 degrees to the right from the portion of the first end 120 that is inserted into the chuck 12, and a second bend 124, which is also angled approximately 90 degrees, aligning the second end 130 of the device 100 parallel to the portion of the first end 120 received by the chuck 12 [Step 202]. Next, the user inserts the first end 120 of the device 100 into the chuck 12 of the reciprocating saw 10 [Step 204]. Once inserted, the device 100 is securely positioned in the saw 10, with the bends 122 and 124 placing the blade-receiving member 132 along the outside edge 11 of the reciprocating saw 10, allowing for flush cuts. Then, a user attaches a Sawzall blade 160 to the blade-receiving member 132 by first unlocking the fastener 152, inserting a tang 164 of the blade 160 into the fastener 152, and securing the blade 160 by engaging at least one opening 166 of the blade 160 with the fastener 152, locking the blade 160 into position [Step 206]. Once the blade 160 is securely fastened to the blade-receiving member 132, the blade 160 is aligned with the outside edge 11 of the reciprocating saw 10. This alignment is facilitated by the bends 122 and 124 of the device 100, which position the blade 160 parallel to the saw 10's outer edge, enabling a flush cut to be made along a surface or edge. A user can then operate the reciprocating saw 10, making the flush cut by guiding the blade 160 along the desired cutting path [Step 208]. The placement of the blade 160 along the outside edge 11 of the reciprocating saw 10 allows for a precise flush cut, which would otherwise be difficult to achieve with a standard reciprocating saw blade.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “Sawzall flush-cut blade attachment device” and “device” are interchangeable and refer to the Sawzall flush-cut blade attachment device 100 of the present invention.

Notwithstanding the foregoing, the Sawzall flush-cut blade attachment device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the Sawzall flush-cut blade attachment device 100 as shown in the FIGS. are for illustrative purposes only, and that many other sizes and shapes of the Sawzall flush-cut blade attachment device 100 are well within the scope of the present disclosure. Although the dimensions of the Sawzall flush-cut blade attachment device 100 are important design parameters for user convenience, the Sawzall flush-cut blade attachment device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A Sawzall flush-cut blade attachment device comprising:
a body comprised of a first end and a second end, the first end being shaped and dimensioned to fit into a chuck of a reciprocating saw;
a first bend formed in the first end at a 90-degree angle;
a second bend formed in the first end, repositioning the second end of the body so that the second end is parallel to a portion of the first end that is inserted into the chuck;
a blade-receiving member attached to the second end of the body; and
a fastener coupled to the blade-receiving member for securing a cutting blade.

2. The Sawzall flush-cut blade attachment device of claim 1, wherein the body is comprised of a high-carbon steel, a high-speed steel, a bi-metal, a carbide-tipped materials, or a diamond grit material.

3. The Sawzall flush-cut blade attachment device of claim 1, wherein the fastener is comprised of a clamp.

4. The Sawzall flush-cut blade attachment device of claim 1, wherein the fastener is comprised of a chuck.

5. The Sawzall flush-cut blade attachment device of claim 1, wherein the cutting blade is comprised of a wood blade, a metal blade, a plastic blade, or a masonry blade.

6. The Sawzall flush-cut blade attachment device of claim 1, wherein the fastener is comprised of a spring-loaded fastener.

7. A Sawzall flush-cut blade attachment device comprising:
a body having a first end adapted to be received by a chuck of the reciprocating saw;
a first bend and a second bend formed in the body, the second bend aligning a second end of the body parallel to a portion of the first end that is inserted into the chuck;
a blade-receiving member attached to the second end of the body;
a fastener on the blade-receiving member for securing a cutting blade; and
a control mechanism operable to unlock the fastener to allow insertion and removal of the cutting blade.

8. The Sawzall flush-cut blade attachment device of claim 7, wherein the cutting blade is comprised of a Sawzall blade.

9. The Sawzall flush-cut blade attachment device of claim 8, wherein the cutting blade is comprised of a tang.

10. The Sawzall flush-cut blade attachment device of claim 8, wherein the cutting blade is comprised of an opening.

11. The Sawzall flush-cut blade attachment device of claim 8, wherein the cutting blade is comprised of a tooth.

12. The Sawzall flush-cut blade attachment device of claim 8, wherein the control mechanism is comprised of a button.

13. The Sawzall flush-cut blade attachment device of claim 8, wherein the fastener is comprised of a clamp.

14. The Sawzall flush-cut blade attachment device of claim 7, wherein the fastener is comprised of a chuck.

15. The Sawzall flush-cut blade attachment device of claim 7, wherein the fastener is comprised of a spring-loaded fastener.

16. A method of using a Sawzall flush-cut blade attachment device, the method comprising the following steps:
providing a device comprised of a body comprised of a first end shaped to fit into a chuck of a reciprocating saw, a first bend at approximately 90 degrees, and a second bend aligning the second end of the body parallel to a portion of the first end received by the chuck;
inserting the first end of the device into the chuck of the reciprocating saw;
attaching a cutting blade to a blade-receiving member on the second end of the body using a fastener; and
operating the reciprocating saw to perform a flush cut along a surface with the blade positioned parallel to the outer edge of the saw.

17. The method of using a Sawzall flush-cut blade attachment device of claim 16, wherein the cutting blade is comprised of a Sawzall blade.

18. The method of using a Sawzall flush-cut blade attachment device of claim 16, wherein the reciprocating saw is comprised of a Sawzall.

19. The method of using a Sawzall flush-cut blade attachment device of claim 16, wherein the fastener is comprised of a clip.

20. The method of using a Sawzall flush-cut blade attachment device of claim 16, wherein the fastener is comprised of a clamp.
